(19) United States
(12) Patent Application Publication
(10) Pub. No.: US 2006/0022579 A1
(43) Pub. Date: Feb. 2, 2006

(54) Organic light emitting diode display panel element and method for manufacturing the same

(76) Inventors: Ling-Yi Wang, Chu-Nan (TW); Chih-Hung Yeh, Chu-Nan (TW); Chien-Hua Yuan, Chu-Nan (TW); Yu-Chun Tseng, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/192,214

(22) Filed: Jul. 29, 2005

(30) Foreign Application Priority Data
Jul. 30, 2004 (TW) 093122986

(51) Int. Cl. H05B 33/14; H05B 33/22; H05B 33/10

(52) U.S. Cl. 313/498; 313/503; 313/504

(57) ABSTRACT

An organic light emitting diode display panel element and a method for manufacturing the same are provided. The element comprises a substrate, a conductive wire layer, a protective layer, an organic light emitting diode structure, and a package body. It first makes the conductive wire layer on the substrate, then coats protective glue on a display area and a non-display area on the substrate, evaporates the organic light emitting diode structure on the display area on the substrate and connects it to the conductive wire layer (connection with electricity conductive ability), and packages the organic light emitting diode structure on the substrate. Therefore, twice protective glue coating process is not needed, it is easy to process the coating process, and the protective glue is more adhesive to the substrate, thus reducing process steps and processing time, meanwhile reducing process expenses.

### FIELD OF THE INVENTION

The present invention is related to an organic light emitting diode display panel element and a method for manufacturing the same, and more particularly to an organic light emitting diode display panel element for reducing process steps.

### BACKGROUND

General display panels (LCD or OLED) have electrode leading wires exposed on a substrate, and the electrode leading wires exposed in an environment are very easily to be affected by moist and temperature in the environment and corroded to cause a short circuit or an broken circuit. Therefore, lifetime of the display is quickly shortened.

Therefore, please refer to FIG. 1. To resolve such a problem of corroding the exposed electrode leading wires, a prior art organic light emitting diode display element 10a further coats a layer of protective layer 12a on an exposed substrate 11a of the packaged organic light emitting diode display element 10a to protect electrode leading wires 13a on the substrate 11a and exposes uncoated area 14a to be connected to external electrical connection element (not shown) to be such that the external electrical connection element is electrically connected to the electrode leading wires 13a on the substrate 11a. Therefore, the electrode leading wires 13a are avoided from corroding by the protective layer 12a protecting the electrode leading wires 13a on the substrate 11a to prevent moist in the environment from contacting with the electrode leading wires 13a.

However, the prior art display element still has defects of resolving the problem of corroding the exposed electrode leading wires. Among them, the steps of the process of the organic light emitting diode display element 10a are sequentially as:

A. Please refer to FIG. 2A, providing a substrate 11a;

B. Making the electrode leading wires 13a on the substrate 11a;

C. Coating the protective layer 12a on the display area 17a of the substrate 11a first, and exposing partial electrode leading wires 13a of the display area 17a;

D. Please refer to FIG. 2B, evaporating the organic light emitting diode structure 15a on the electrode leading wires 13a of the protective layer 12a and the display area 17a;

E. Please refer to FIG. 2C, using a package process to seal package the organic light emitting diode structure 15a on the display area 17a of the substrate 11a by a package body 16a;

F. Please refer to FIG. 2, proceeding a coating process of the protective layer 12a on the exposed substrate 11a out of the package body 16a, and the coasting process uses a dispenser to coat protective glue on the substrate 11a and the electrode leading wires 13a. However, usually because of the shape of the package body 16a and other limitations, the protective glue is not easy to be evenly coated on the substrate 11a out of the package body 16a to cause the solidified degree of the protective glue 12a bad and easily generate many defects, and thus affecting good or coarse of the coating quality. Therefore, the moisture cannot be effectively obstructed from permeating between the substrate 11a and the protective layer 12a such that the electrode leading wires 13a covered by the protective layer 12a are still corroded. Besides, the substrate 11a has twice protective glue coating process, and thus increasing process steps and extending processing working hours. Meanwhile, the process cost raises, losing the compatibly of products.

### SUMMARY OF THE INVENTION

The present invention is related to an organic light emitting diode display panel element and a method for manufacturing the same which coats a protective layer on a display area and a non-display area of a substrate prior to evaporating the organic light emitting diode structure on the glass structure. Therefore, the protective layer and the glass substrate are easily to be tightly connected to reduce process steps and processing time and lower the cost. Meanwhile, the solidified protective layer protects leading wires on the substrate to prevent the leading wires corroding which is affected by moisture and temperature attacking.

According to the previous mentioned objects, the present invention provides an organic light emitting diode display panel element which comprises a substrate, at least one conductive wire layer, at least one protective layer, at least one organic light emitting diode structure, and a package body. Among them, a surface of the substrate has a display area and a non-display area, and the display area and the non-display area adjacent to each other. The at least one conductive wire layer is spread on the surface of the substrate and extended to the display area and the non-display area. The at least one protective layer is spread on the display area and the non-display area of the substrate, covering the at least one conductive wire layer thereon, and exposing partial conductive layer of the display area and the non-display area. The at least one organic light emitting diode structure is spread on the protective layer of the display area and on the at least one conductive layer of the exposed display area. The package body covers the at least one organic light emitting diode structure in the display area of the substrate and adheres to the at least one protective layer.

Besides, a process of an organic light emitting diode display element comprises the steps of:
providing a substrate whose surface has a display area and a non-display area, and the display area and the non-display area adjacent to each other;
making at least one conductive wire layer on the substrate and extending them to the display area and the non-display area;
spreading at least one protective layer on the substrate, covering the display area and the non-display area on the substrate, and exposing partial conductive layer of the display area and the non-display area;
spreading at least one organic light emitting diode structure on the display area on the substrate and the partial conductive layer of the exposed display area; and
packaging the at least one organic light emitting diode structure on the display area of the substrate. This way, the process steps and processing time is reduced, and the cost is lowered. Meanwhile the solidified protective layer protects the electricity conducting wires on the substrate to prevent the electricity conducting wires from corroding by moist and temperatures.

### BRIEF DESCRIPTION OF DRAWINGS

FIG. 1 is a vertical view of a prior art organic light emitting diode display element;

FIG. 2 is a cross section diagram of the prior art organic light emitting diode display module;

FIG. 2A to FIG. 2C are manufacturing flow charts of the prior art organic light emitting diode display element;

FIG. 3 is a cross section diagram of an organic light emitting diode display element module of the present invention;

FIG. 3A to FIG. 3D are manufacturing flow charts of the organic light emitting diode display module of the present invention;

FIG. 4 is a vertical view of simultaneously making a plurality of organic light emitting diode display elements on a big substrate in accordance with the present invention;

FIG. 5 to FIG. 7 are vertical views of an embodiment of the organic light emitting diode display element of the present invention; and

FIG. 8 is a top view of the organic light emitting diode display element.

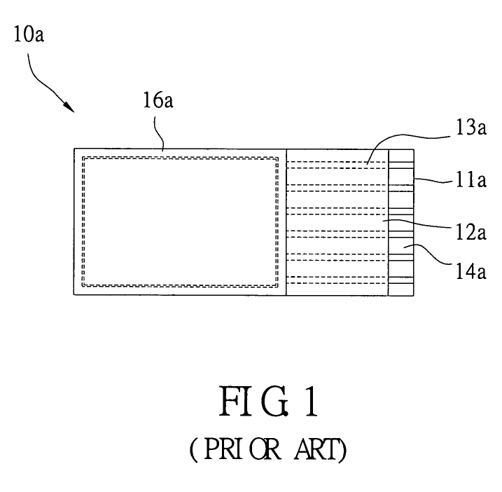

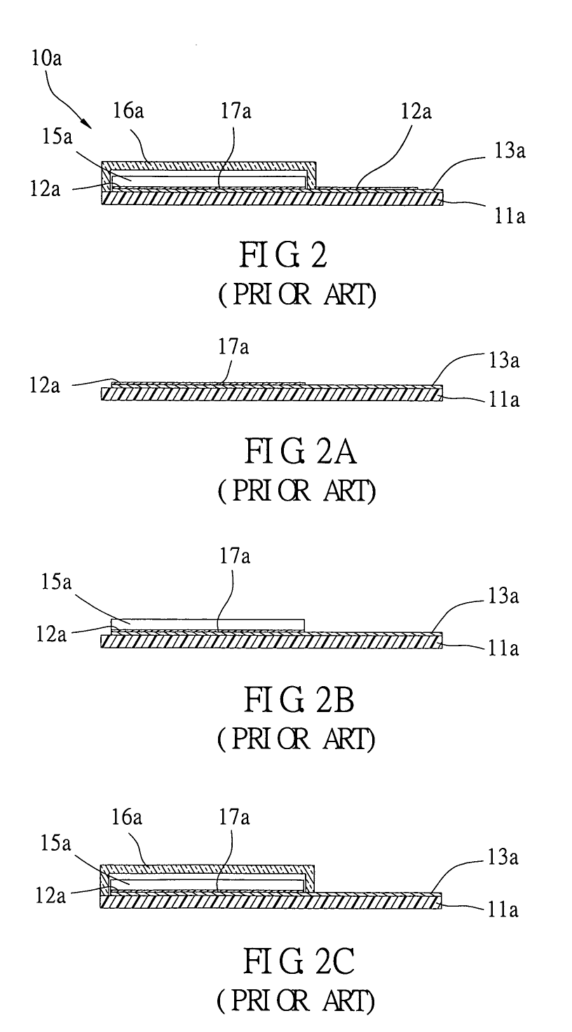

### DETAILED DESCRIPTION

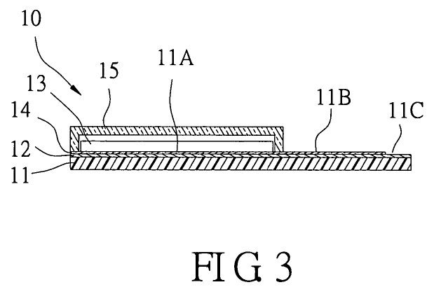

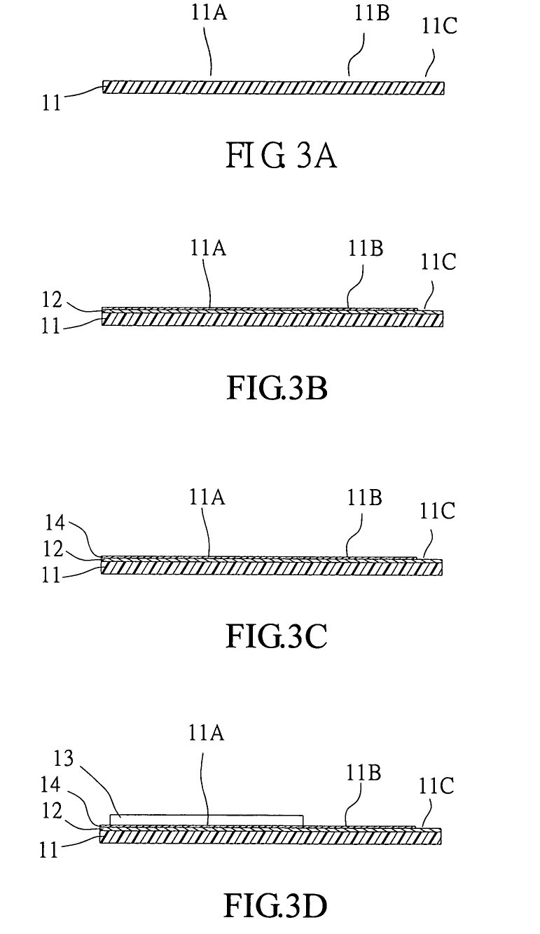

Please refer to FIG. 3, an organic light emitting diode display element 10 and a method of manufacturing the same of the present invention. The element comprises a substrate 11, a conductive wire layer 12, an organic light emitting diode structure 13, a protective layer 14, and a package body 15. Among them, the conductive wire layer 12 is made on the substrate 11 first, then the protective layer 14 covers on the substrate 11, partial area on the substrate 11 is exposed, the organic light emitting diode structure 13 is evaporated on the partial area on the substrate 11 and electrically connected to the electricity conductive wire 12, and the organic light emitting diode structure 13 is packaged on the substrate 11. This way, the protective layer 14 is easily and firmly attached to the substrate 11 and the conductive wire layer 12 by changing the process to protect the conductive wire layer 12 on the substrate 11 to avoid moisture and temperature factor from oxidizing or corroding the electricity conductive wire 12.

Among them, the process of the organic light emitting diode display element 10 has the steps of:

Please refer to FIG. 3A, providing a substrate 11. A surface of the substrate 11 has a display area 11A, a non-display area 11B, and an external electrical connection area 11C, and the substrate 11 can be a glass substrate.

Please refer to FIG. 3B, making at least one conductive wire layer 12 on the substrate 11 to extend to the display area 11A, the non-display area 11B, and the external electrical connection area 11C. The conductive wire layers 12 can use a lithographically etching technology to make metallic leading wires or Indium-Tin Oxide (ITO) wires on the substrate 11.

Please refer to FIG. 3C, spreading a protective layer 14 on the substrate 11, covering the conductive wire layer 12 of the display area 11A and the non-display area 11B on the substrate 11, and exposing partial area of the conductive wire layer 12 of the display area 11A and the non-display area 11B. The protective layer 14 can be a macromolecule photoresist material with high dielectricity and low permeability. The photoresist material can be polyimide (PI) material and can use spin coating to be coated on the substrate 11. Then a way of lithographically etching is used to remove the area on the substrate 11 which does not need to cover photoresist, such as the external electrical connection area 11C and part of the display area 11A.

Please refer to FIG. 3D, spreading at least one organic light emitting diode structure 13 on the protective layer 14 and conductive wire layer 12 of the display area 11A. Among them, the organic light emitting diode structure 13 can use an evaporation process to be provided on the display area 11A such that the organic light emitting diode structure 13 is electrically connected to the conductive wire layer 12, and the protective layer 14 is used to isolate from partial conductive wire layer 12.

Please refer to FIG. 3, packaging at least one organic light emitting diode structure 13 on the display area 11A of the substrate 11. Among them, the package body 15 can be used to cover and seal the organic light emitting diode structure 13 on the substrate 11, and the protective layer 14 of the display area 11A can be sealed by the package body 15.

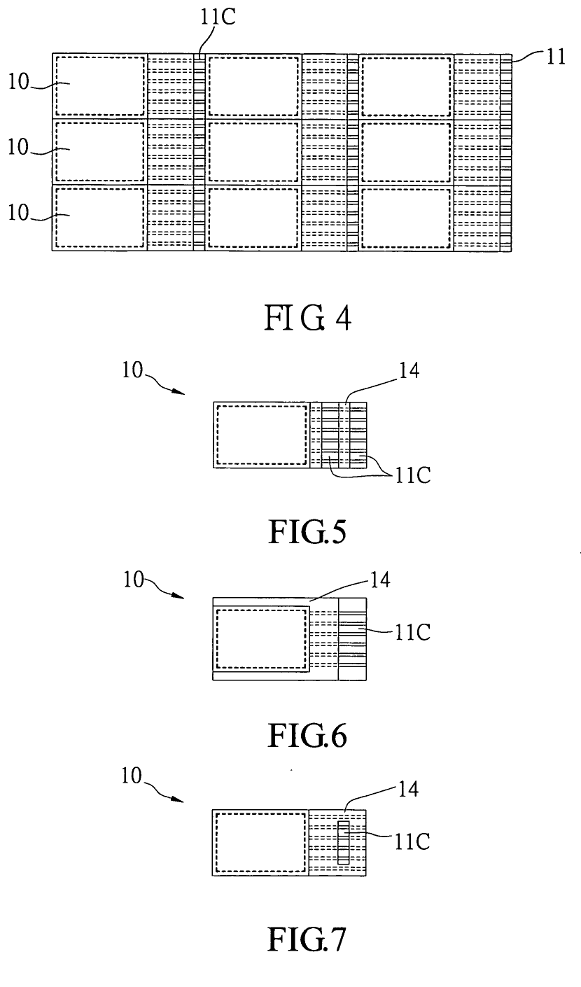

Besides, please refer to FIG. 4. When simultaneously making a plurality of organic light emitting diode display elements 10 on a large-area substrate 11 with the above mentioned process, a scribing & breaking process is used on the substrate 11 to separate individual organic light emitting diode display element 10 after completing the package process. Thereafter, an fabrication process is used to make the external electrical connection area 11C of the organic light emitting diode display element 10 electrically connect to the electrical connection element (not shown) to be fabricated and electrically connected to other devices. Further, please refer to FIG. 5 to FIG. 7; the protective layer 14 further has other types of covering on the substrate, which all exposes the external electrical connection area 11C.

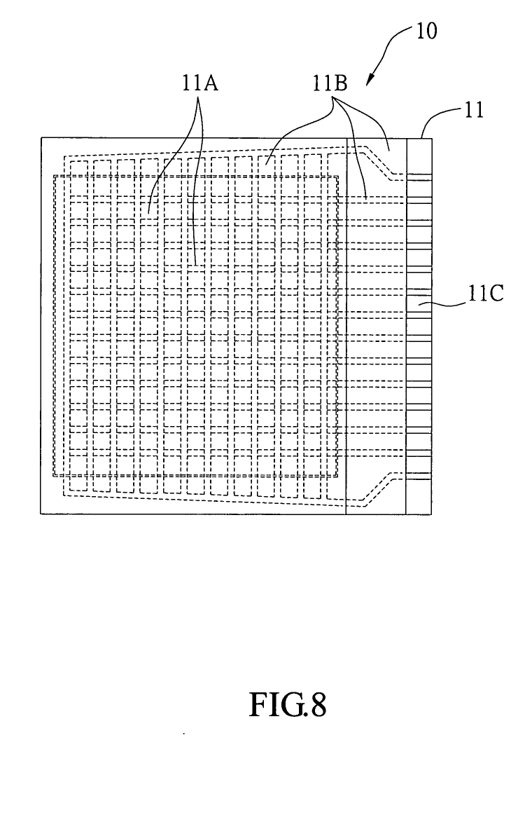

Hereafter, FIG. 8 is used to briefly describe a structure of the organic light emitting diode display element. Among them, the display area 11A is made of an organic light emitting diode, and the external electrical connection area 11C of external non-display area 11B is used to connect to cathode and anode to enter the display area 11A (including a cathode conductive wire layer of both sides of the display area 11A and anode conductive wire layer below the display area 11A). The light emitting principle is using the cathode and anode to guide the organic light emitting diode to emit light.

In summary, the “organic light emitting diode display element” of the present invention coats photoresist on the display area and non-display area on the substrate prior to the organic light emitting diode structure spread on the substrate by changing the process. Therefore, the coating process is not limited by the shape of the package body such that the protective glue is easily and evenly spread and attached on the substrate. In addition, it is no need to re-coat the protective glue after completing packaging, and thus the process steps and processing time is reduced. This way, the cost is lowered. Meanwhile, the solidified protective layer protects the conductive wires on the substrate to prevent the conductive wires from corroding by moist and temperature.

The foregoing description is merely one embodiment of present invention and not considered as restrictive. All equivalent variations and modifications in process, method, feature, and spirit in accordance with the appended claims may be made without in any way from the scope of the invention.

1. An organic light emitting diode display element, comprising:
a substrate having a display area and a non-display area on the surface of said substrate, and said display area and said non-display area adjacent to each other;
at least one conductive wire layer spread on said surface of said substrate and extended to said display area and said non-display area;
at least one protective layer spread on said display area and said non-display area of said substrate, covering said at least one conductive wire layer thereon, and exposing partial conductive layer of said display area and said non-display area; and
at least one organic light emitting diode structure spread on said protective layer of said display area and on said partial conductive layer of said exposed display area; and
a package body covering said at least one organic light emitting diode structure in said display area of said substrate and adhered to said at least one protective layer.

2. The organic light emitting diode display element according to claim 1, wherein said at least one conductive wire layer comprises metallic conductive wires and ITO conductive wires.

3. The organic light emitting diode display element according to claim 1, wherein said at least one protective layer is a photoresist material layer.

4. The organic light emitting diode display element according to claim 1, wherein said at least one protective layer is a polyimide (PI) material.

5. The organic light emitting diode display element according to claim 1, wherein the surface of said substrate further comprises an external electrical connection area, and said at least one conductive wire layer is extended to said external electrical connection area.

6. A process of an organic light emitting diode display element, comprising the steps of:
providing a substrate having a display area and a non-display area on the surface of said substrate, and said display area and said non-display area adjacent to each other;
making at least one conductive wire layer on said substrate and extending them to said display area and said non-display area;
spreading at least one protective layer on said substrate, covering said display area and said non-display area on said substrate, and exposing partial conductive layer of said display area and said non-display area;
spreading at least one organic light emitting diode structure on said display area on said substrate and said partial conductive layer of said exposed display area; and
packaging said at least one organic light emitting diode structure on said display area of said substrate.

7. The process of an organic light emitting diode display element according to claim 6, wherein said spreading a protective layer on said substrate coat said protective layer on said substrate by a coating process.

8. The process of an organic light emitting diode display element according to claim 6, wherein said spreading a protective layer on said substrate coat said protective by a dispenser.

9. The process of an organic light emitting diode display element according to claim 6, wherein said packaging said at least one organic light emitting diode structure on said display area of said substrate seal said at least one organic light emitting diode structure on said display area of said substrate by a cover.

10. The process of an organic light emitting diode display element according to claim 6, wherein said surface of said substrate further comprises an external electrical connection area adjacent to said non-display area, and said at least one conductive wire layer is extended to said non-display area to electrically connect to an electrical connection element.
